(19) United States
(12) Patent Application Publication
(10) Pub. No.: US 2025/0293458 A1
(43) Pub. Date: Sep. 18, 2025

(54) SAFE CONNECTING STRUCTURE AND SAFE CONNECTOR

(71) Applicant: DELTA ELECTRONICS, INC., Taoyuan City (TW)

(72) Inventors: Jun-Fu LEE, Taoyuan City (TW); Wei-Kai HSIAO, Taoyuan City (TW)

(21) Appl. No.: 18/675,158

(22) Filed: May 28, 2024

(30) Foreign Application Priority Data
Mar. 15, 2024 (CN) 202410297583.2

(51) Int. Cl. H01R 13/625

(52) U.S. Cl. CPC H01R 13/625

(57) ABSTRACT

A safe connecting structure includes a first connector and a second connector removably connected to the first connector. The first connector includes a first outer housing, a first inner housing, a first conductive terminal, a first connecting bridge, and a conductive rod. The first inner housing has a first opening. The first conductive terminal is located in the first opening in the first inner housing. The first connecting bridge is accommodated in the first outer housing and rotatable in the first outer housing. The conductive rod passes through and fixed to the first connecting bridge, and the conductive rod protrudes outward first outer housing along a combining direction. The second connector includes a second outer housing and a second conductive terminal. The second outer housing is configured to be coupled to the first outer housing. The second conductive terminal is located in the second outer housing.

### CROSS-REFERENCE TO RELATED APPLICATION

This application claims priority to China Application Serial Number 202410297583.2, filed Mar. 15, 2024, which is herein incorporated by reference in its entirety.

### BACKGROUND

### Field of Invention

The present invention relates to a safe connecting structure and a safe connector.

### Description of Related Art

As connector products continue to evolve, the safety of connectors has gradually received attention. For example, according to IEC60335, as the output voltage exceeds 42 volts, the metal at the output end of the connector must not be exposed or the detection voltage of the exposed metal must not exceed 42 volts. Although existing connectors are equipped with protective covers or are designed to retract the metal ends inward to increase safety, as the connector is tested for safety regulations, the probes used for safety testing are slender in structure, resulting in being contacted by probes even if the connectors on the market are made of non-exposed metal, thereby being not comply with safety regulations such as IEC60335.

### SUMMARY

In view of this, one purpose of the present disclosure is to provide a safe connecting structure and a safe connector that can solve the aforementioned problems.

In order to achieve the above objective, according to an embodiment of the present disclosure, a safe connecting structure includes a first connector and a second connector removably connected to the first connector. The first connector includes a first outer housing, a first inner housing, a first conductive terminal, a first connecting bridge, and a conductive rod. The first inner housing is located in the first outer housing. The first inner housing has a first opening. The first conductive terminal is located in the first opening of the first inner housing. The first connecting bridge is accommodated in the first outer housing and is rotatable in the first outer housing. The conductive rod passes through the first connecting bridge and is fixed to the first connecting bridge. The conductive rod protrudes outward from the first outer housing along a joining direction. The second connector includes a second outer housing and a second conductive terminal. The second outer housing is configured to be coupled to the first outer housing. The second conductive terminal is located in the second outer housing. The conductive rod is not aligned with the first opening and is in a non-conductive state with the first conductive terminal in the first opening as the first connector is not connected to the second connector. The conductive rod is connected to the second conductive terminal, and the first outer housing rotates relative to the second outer housing around a rotation axis parallel to the joining direction. The first inner housing rotates with the first outer housing until the first opening is aligned with the conductive rod. The first connector and the second connector are further pushed together along the joining direction, such that the conductive rod passes through the first opening to connect the first conductive terminal, and the first conductive terminal is in a conductive state with the second conductive terminal by the conductive rod, as the first connector is connected to the second connector along the joining direction.

In one or more embodiments of the present disclosure, the first connector includes a first guiding mechanism. The second connector includes a second guiding mechanism. The first guiding mechanism and the second guiding mechanism are configured to assist the first connector and the second connector to move or rotate relative to each other.

In one or more embodiments of the present disclosure, the first guiding mechanism includes a groove disposed on the outer surface of the first outer housing. The groove has a first groove, a second groove communicating with the first groove, and a recess located at an end of the second groove. The second guiding mechanism includes a cantilever disposed on an outer surface of the second outer housing. The cantilever has a free end and a fixed end fixed to the second outer housing. The free end of the cantilever moves in the first groove and the second groove as the first connector and the second connector move or rotate relative to each other.

In one or more embodiments of the present disclosure, the free end of the cantilever moves in the first groove as the first outer housing rotates relative to the second outer housing. The free end of the cantilever moves in the second groove after the first opening is aligned with the conductive rod and the first connector and the second connector are further pushed together along the joining direction.

In one or more embodiments of the present disclosure, as the first connector and the second connector are further pushed together along the joining direction, the free end of the cantilever moves in the second groove, so that the free end of the cantilever is buckled in the recess.

In one or more embodiments of the present disclosure, the second guiding mechanism includes a groove disposed on an outer surface of the second outer housing. The groove has a first groove, a second groove communicating with the first groove, and a recess located at an end of the second groove. The first guiding mechanism includes a cantilever disposed on an outer surface of the first outer housing. The cantilever has a free end and a fixed end fixed to the first outer housing. The free end of the cantilever moves in the first groove and the second groove as the first connector and the second connector move or rotate relative to each other.

In one or more embodiments of the present disclosure, the free end of the cantilever moves in the first groove as the first outer housing rotates relative to the second outer housing. The free end of the cantilever moves in the second groove after the first opening is aligned with the conductive rod and the first connector and the second connector are further pushed together along the joining direction.

In one or more embodiments of the present disclosure, as the first connector and the second connector are further pushed together along the joining direction, the free end of the cantilever moves in the second groove, so that the free end of the cantilever is buckled in the recess.

In one or more embodiments of the present disclosure, the first inner housing further includes an arc-shaped groove disposed adjacent to a surface of the first connecting bridge. The first opening of the first inner housing is connected to an end of the arc-shaped groove.

In one or more embodiments of the present disclosure, the second connector further includes a second inner housing located in the second outer housing. The second inner housing has a second opening to accommodate the second conductive terminal.

In one or more embodiments of the present disclosure, the second connector further includes a second connecting bridge. The conductive rod passes through the second connecting bridge and is connected to the second conductive terminal.

In one or more embodiments of the present disclosure, the first connector further includes an elastic part disposed between the first inner housing and the first connecting bridge.

In order to achieve the above objective, according to an embodiment of the present disclosure, a safe connector includes an outer housing, an inner housing, a conductive terminal, a connecting bridge, and a conductive rod. The inner housing is located in the outer housing. The inner housing has an opening. The conductive terminal is located in the opening of the inner housing. The connecting bridge is accommodated in the outer housing and rotatable in the outer housing. The conductive rod passes through the connecting bridge and is fixed to the connecting bridge. The conductive rod protrudes outward from the outer housing along a joining direction. The conductive rod is not aligned with the opening and is in a non-conductive state with the conductive terminal in the opening as the safe connector is in an unconnected state. As the inner housing rotates relative to the connecting bridge around a rotation axis parallel to the joining direction until the opening is aligned with the conductive rod, and the inner housing and the connecting bridge are further pushed together along the joining direction, the conductive rod passes through the opening to connect the conductive terminal, such that the conductive terminal is in a conductive state with the conductive rod.

In one or more embodiments of the present disclosure, the outer housing has a first groove on an outer surface of the outer housing, a second groove connected to the first groove, and a recess located at an end of the second groove.

In one or more embodiments of the present disclosure, the outer housing has a cantilever on an outer surface of the outer housing. The cantilever has a free end and a fixed end fixed to the housing.

In one or more embodiments of the present disclosure, the inner housing further includes an arc-shaped groove disposed adjacent to a surface of the connecting bridge. The opening of the inner housing is connected to an end of the arc-shaped groove. An end of the conductive rod close to the inner housing moves along the arc-shaped groove as the inner housing rotates relative to the connecting bridge.

In one or more embodiments of the present disclosure, the safe connector further includes an elastic part disposed between the inner housing and the connecting bridge.

In summary, in the safe connecting structure and the safe connector of the present disclosure, since the first inner housing has the first opening, the conductive rod can be blocked first and not immediately pass through the first opening and contact the first conductive terminal as the user couples the first connector and the second connector, thereby achieving the effect of non-conducting while the conductive rod is still exposed. In the safe connecting structure and safe connector of the present disclosure, since the arc-shaped groove has an arc shaped and is configured for the conductive rod to abut against, the arc-shaped groove can guide the conductive rod to move in the arc-shaped groove as the first connector and the second connector rotate relative to each other. Overall, the safe connecting structure and safe connector of the present disclosure improve the safety of the user using the connector.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a safe connecting structure in accordance with an embodiment of the present disclosure;

FIG. 2 is an exploded view of the safe connecting structure in accordance with an embodiment of the present disclosure;

FIG. 3 is a perspective view of a first inner housing in accordance with an embodiment of the present disclosure;

FIG. 4 is a perspective cross-sectional view of the safe connecting structure in a first state based on a section A-A′ of FIG. 1 in accordance with an embodiment of the present disclosure;

FIG. 5 is a cross-sectional view of a first connector in the first state based on a section B-B′ of FIG. 1 in accordance with an embodiment of the present disclosure;

FIG. 6 is a perspective cross-sectional view of the safe connecting structure in a second state based on the section A-A′ of FIG. 1 in accordance with an embodiment of the present disclosure;

FIG. 7 is a cross-sectional view of the first connector in the second state based on the section B-B′ of FIG. 1 in accordance with an embodiment of the present disclosure;

FIG. 8 is a perspective cross-sectional view of the safe connecting structure in a third state based on the section A-A′ of FIG. 1 in accordance with an embodiment of the present disclosure;

FIG. 9 is a cross-sectional view of the first connector in the third state based on the section B-B′ of FIG. 1 in accordance with an embodiment of the present disclosure;

FIG. 10 is a perspective cross-sectional view of the safe connecting structure in a fourth state based on the section A-A′ of FIG. 1 in accordance with an embodiment of the present disclosure; and

FIG. 11 is a cross-sectional view of the first connector in the fourth state based on the section B-B′ of FIG. 1 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a safe connecting structure 100 of this embodiment and the connection relationship between the components will be described in detail.

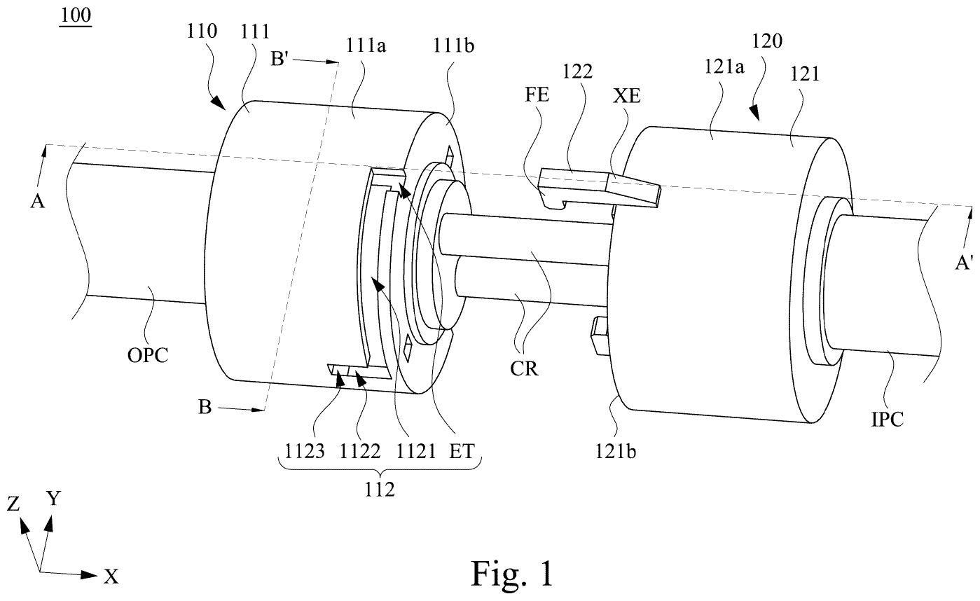

Reference is made to FIG. 1. FIG. 1 is a perspective view of a safe connecting structure in accordance with an embodiment of the present disclosure. As shown in FIG. 1, in this embodiment, the safe connecting structure 100 includes a first connector 110 and a second connector 120. The first connector 110 is removably connected to the second connector 120 and configured to rotate relative to the second connector 120. The first connector 110 and the second connector 120 are configured to couple with each other. The first connector 110 includes a first outer housing 111, a conductive rod CR, and an output cable OPC. The second connector 120 includes a second outer housing 121 and an input cable IPC. In this embodiment, the output cable OPC is electrically connected to the input cable IPC by the conductive rod CR. The output cable OPC is connected to the first outer housing 111. The output cable OPC protrudes from the first outer housing 111 and is extended in a direction away from the conductive rod CR. The conductive rod CR protrudes outward from the first outer housing 111 along a joining direction (e.g., x-direction) to be coupled with the second connector 120. The second outer housing 121 is configured to be coupled with the first outer housing 111 and accommodate the conductive rod CR. The joining direction refers to a direction in which the first connector 110 moves toward the second connector 120 to connect to each other.

In some embodiments, the first connector 110 and the second connector 120 have a corresponding first guiding mechanisms and a corresponding second guiding mechanisms respectively to assist the first connector 110 and the second connector 120 to perform connection actions such as relative movement or rotation. In this embodiment, a groove 112 is adopted in the first guiding mechanism, and a cantilever 122 is adopted in the second guiding mechanism.

As shown in the embodiment of FIG. 1, the first connector 110 has the groove 112. The first outer housing 111 has an outer surface 111a. The groove 112 is disposed on the outer surface 111a of the first outer housing 111. The groove 112 has an entrance ET, a first groove 1121 and a second groove 1122. The entrance ET is connected to an end of the first groove 1121, the second groove 1122 is connected to the other end of the first groove 1121, and a recess 1123 is provided at an end of the second groove 1122. As shown in the embodiment of FIG. 1, the structural configuration of the entrance ET, the first groove 1121, and the second groove 1122 forms the groove 112 having a zigzag shape.

As shown in the embodiment of FIG. 1, the second connector 120 includes the cantilever 122. The second outer housing 121 has an outer surface 121a. The cantilever 122 is disposed on the outer surface 121a of the second outer housing 121. The cantilever 122 has a fixed end XE and a free end FE. The fixed end XE is disposed on the outer surface 121a of the second outer housing 121. The free end FE is located at an end of the cantilever 122 away from the second outer housing 121. The free end FE of the cantilever 122 is configured to move in the groove 112 (e.g., the free end FE of the cantilever 122 is configured to move in the first groove 1121 and the second groove 1122), so that the free end FE of the cantilever 122 moves in the first groove 1121 as the first connector 110 and the second connector 120 rotate around an axis in the x-direction in FIG. 1. When the second connector 120 and the first connector 110 are coupled together along a direction (e.g., x-direction), the free end FE of the cantilever 122 moves in the second groove 1122. As shown in the embodiment of FIG. 1, when the first connector 110 and the second connector 120 are connected, the free end FE of the cantilever 122 enters the first groove 1121 and the second groove 1122 through the entrance ET and is buckled into the recess 1123, so that the first connector 110 and the second connector 120 can remain positioned without being disengaged after being connected.

In some embodiments, the first connector 110 is a power output end of the safe connecting structure 100, and the second connector 120 is a power input end of the safe connecting structure 100. In some embodiments, the first connector 110 is the power input end of the safe connecting structure 100, and the second connector 120 is the power output end of the safe connecting structure 100.

As shown in FIG. 1, in some embodiments, the quantity of the conductive rod CR is two. However, the present disclosure is not intended to limit the quantity of the conductive rod CR. The quantity of conductive rods CR can be set to an appropriate quantity based on different design considerations.

In other embodiments, the first guiding mechanism and the second guiding mechanism can also be implemented in other appropriate ways. In this embodiment, the first connector 110 includes the groove 112 for coupling with the corresponding cantilever 122 of the second connector 120. In other embodiments, the first connector 110 includes a groove and a cantilever, which can be combined with the corresponding cantilever and groove of the second connector 120 respectively. In other embodiments, the first connector 110 may have two grooves disposed oppositely on the outer surface 111a, and the second connector 120 may include two cantilevers disposed corresponding to the two grooves. However, the present disclosure is not intended to limit the quantities of grooves and cantilevers. In another embodiment, the first connector 110 includes a cantilever to engage with a corresponding groove of the second connector 120. In addition, the grooves and cantilevers can also be disposed at appropriate positions on the outer surface 111a or the outer surface 121a respectively, and their shapes can be adjusted accordingly. In another embodiment, the groove and/or the cantilever of the first connector 110 is disposed on a first adjacent surface 111b of the outer surface 111a. When the first connector 110 and the second connector 120 are connected, the first adjacent surface 111b will be adjacent to the second adjacent surface 121b of the outer surface 121a of the second connector 120 to combine with the corresponding cantilever and/or groove disposed on the second adjacent surface 121b. In another embodiment, the groove can also be disposed under the outer surface of the connector without exposing the groove-like structure.

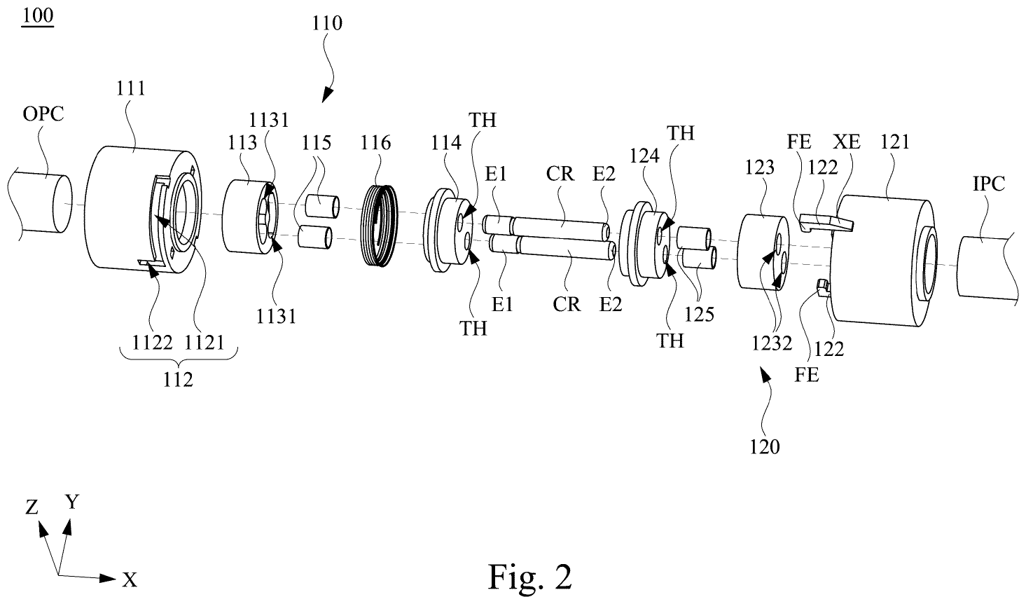

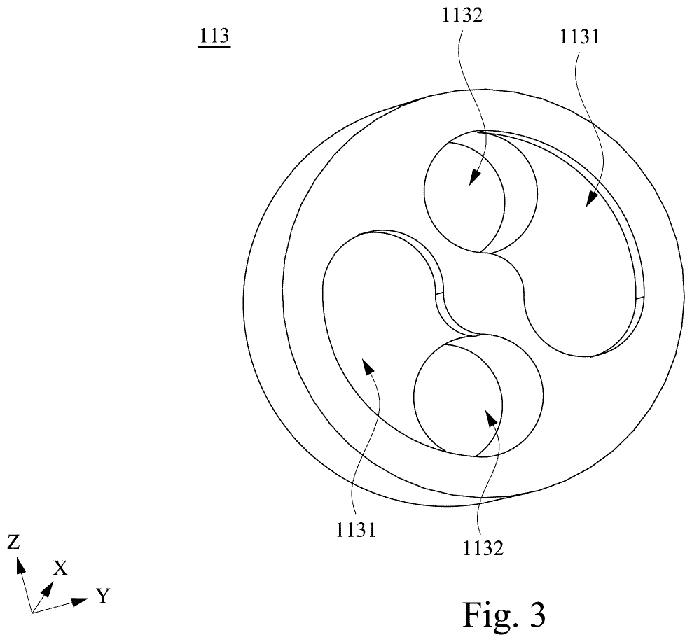

Reference is made to FIG. 2. FIG. 2 is an exploded view of the safe connecting structure 100 in accordance with an embodiment of the present disclosure. In this embodiment, the first connector 110 further includes a first inner housing 113, a first connecting bridge 114, a first conductive terminal 115, and an elastic part 116. The second connector 120 further includes a second inner housing 123, a second connecting bridge 124, and a second conductive terminal 125. The first inner housing 113 is located in the first outer housing 111. The first inner housing 113 has an arc-shaped groove 1131 and a first opening 1132 (referring to FIG. 3). The arc-shaped groove 1131 is disposed adjacent to a surface of the first connecting bridge 114. The conductive rod CR is configured to move along the arc-shaped groove 1131. The first conductive terminal 115 is located in the first opening 1132 of the first inner housing 113 and is electrically connected to the output cable OPC. The elastic part 116 is disposed between the first inner housing 113 and the first connecting bridge 114. The second inner housing 123 is located inside the second outer housing 121. The conductive rod CR passes through the first connecting bridge 114 and is fixed with the first connecting bridge 114 in an appropriate location. The conductive rod CR extends beyond both ends of the first connecting bridge 114. When the first connector 110 and the second connector 120 are correctly connected, the conductive rod CR can be connected to the first conductive terminal 115 and the second conductive terminal 125. When the first connector 110 is not connected to the second connector 120 or is not connected correctly, the conductive rod CR is not connected to the first conductive terminal 115 and not conductive. The second conductive terminal 125 is located in the second inner housing 123.

As shown in FIG. 2, the first connecting bridge 114 has a plurality of openings, which are called through holes TH to distinguish them from other elements. The second connecting bridge 124 has a plurality of openings, which are called through holes TH to distinguish them from other elements. The conductive rod CR has a first end E1 and a second end E2. The first end E1 of the conductive rod CR passes through the first connecting bridge 114 through the through holes TH of the first connecting bridge 114 and extends beyond the first connecting bridge 114 by an appropriate length and can be connected to the first conductive terminal 115 through operation. The second end E2 of the conductive rod CR also extends beyond the first connecting bridge 114 by an appropriate length. When the first connector 110 is connected to the second connector 120, the second end E2 of the conductive rod CR can pass through the second connecting bridge 124 through the through holes TH of the second connecting bridge 124. The first end E1 is an end of the conductive rod CR close to the output cable OPC, and the second end E2 is an end of the conductive rod CR close to the input cable IPC. The first end E1 of the conductive rod CR moves along the arc-shaped groove 1131.

As shown in FIG. 2, the second inner housing 123 has a second opening 1232 configured for the conductive rod CR to penetrate. The second conductive terminal 125 is accommodated in the second opening 1232 of the second inner housing 123.

As shown in FIG. 2, in some embodiments, the quantity of the first conductive terminals 115 and the quantity of the second conductive terminals 125 are two, respectively, and the quantity of the second opening 1232 is two. Specifically, the quantities of the first conductive terminals 115, the second conductive terminals 125 and the second opening 1232 are substantially equal to the quantity of the conductive rods CR. However, the present disclosure is not intended to limit the quantities of the first conductive terminals 115, the second conductive terminals 125 and the second opening 1232.

Reference is made again to FIG. 3. FIG. 3 is a perspective view of the first inner housing 113 in accordance with an embodiment of the present disclosure. The first inner housing 113 further includes a first opening 1132. The first opening 1132 of the first inner housing 113 is connected to one end of the arc-shaped groove 1131. In some embodiments, the first opening 1132 of the first inner housing 113 runs through the first inner housing 113 along the joining direction (e.g., x-direction). In some embodiments, the first conductive terminal 115 is accommodated in the first opening 1132 of the first inner housing 113. In some embodiments, the conductive rod CR is configured to abut the arc-shaped groove 1131. After the first connecting bridge 114 and the conductive rod CR fixed to the first connecting bridge 114 rotate relative to the first inner housing 113 through the operation, the conductive rod CR can be aligned with the first opening 1132, so that the conductive rod CR can be pushed into the first opening 1132 to contact the first conductive terminal 115 and the conductive rod CR cannot contact the first conductive terminal 115 as the conductive rod CR is pulled away from the first opening 1132.

In some embodiments, the first inner housing 113 may not be provided with the arc-shaped groove 1131. In some other embodiments, circular grooves or other appropriately shaped guiding mechanisms may also be adopted by the first inner housing 113, so that the conductive rod CR moves along edges of the circular grooves or these guiding mechanisms, thereby the conductive rod CR moving to be aligned or misaligned with the first opening 1132.

In some embodiments, the quantity of first opening 1132 is two. Specifically, the quantity of first opening 1132 is substantially equal to the quantity of the conductive rod CR and the quantity of arc-shaped groove 1131. However, the present disclosure is not intended to limit the quantity of first opening 1132.

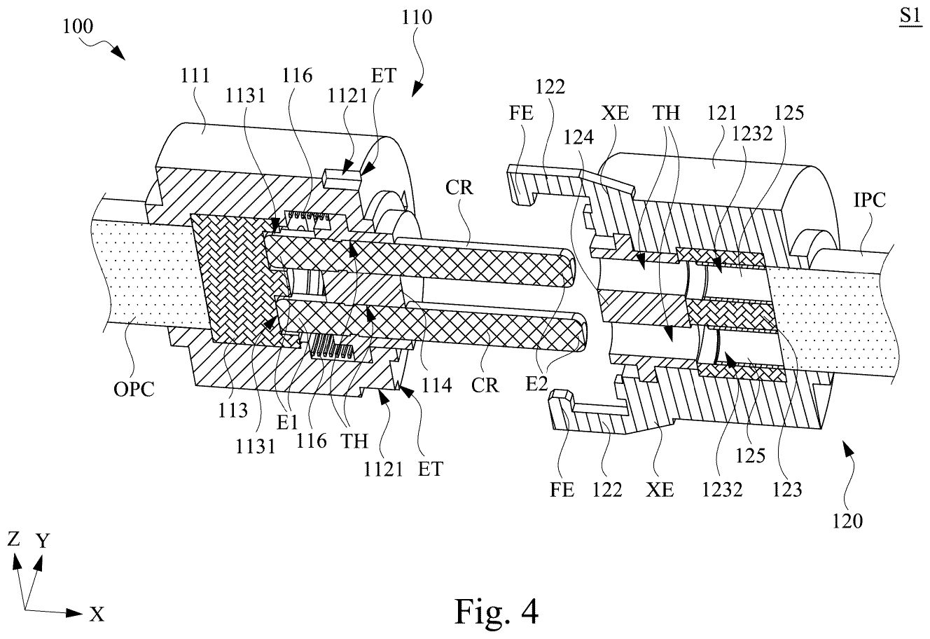

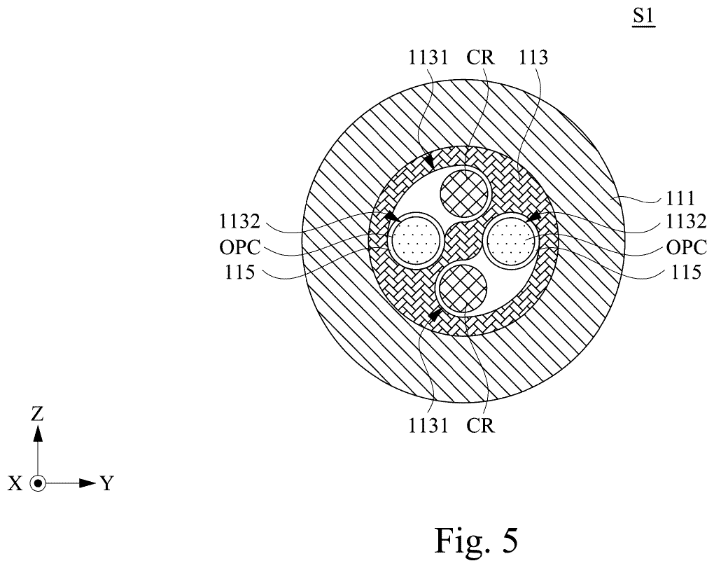

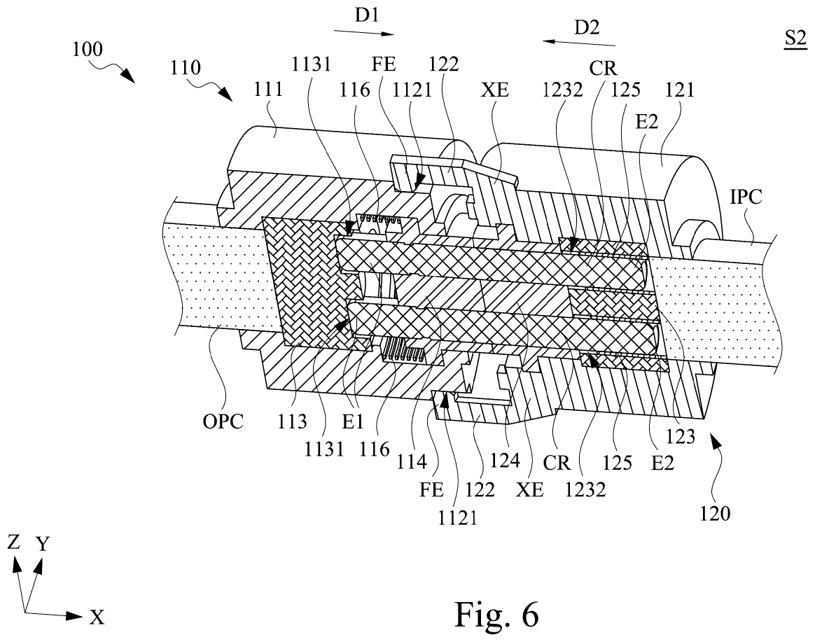

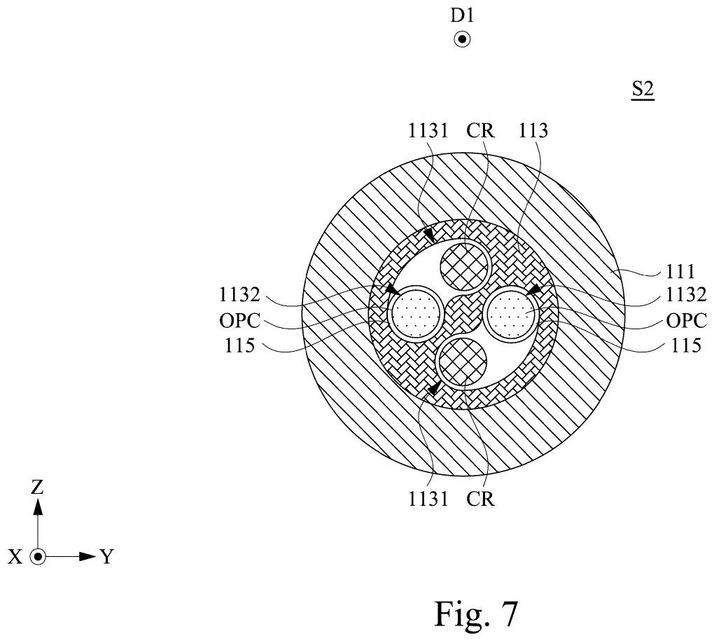

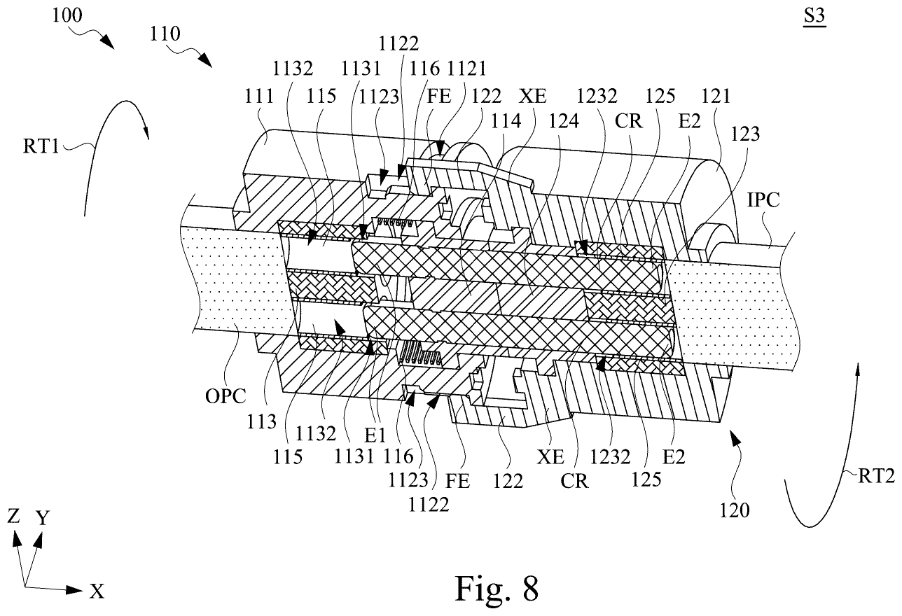

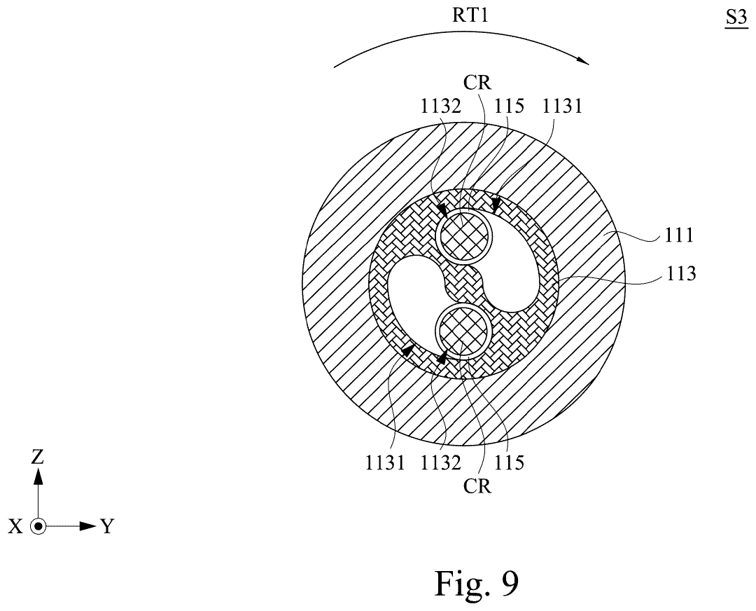

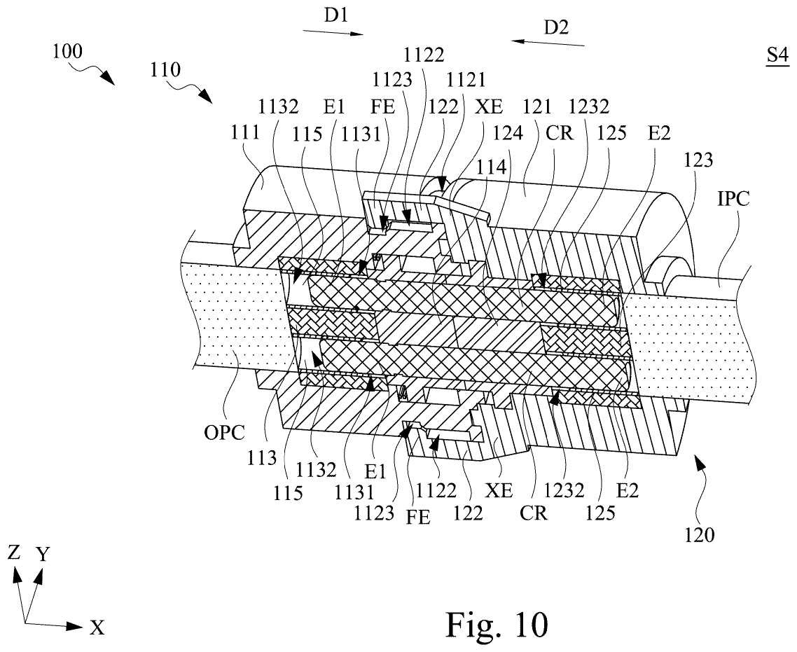

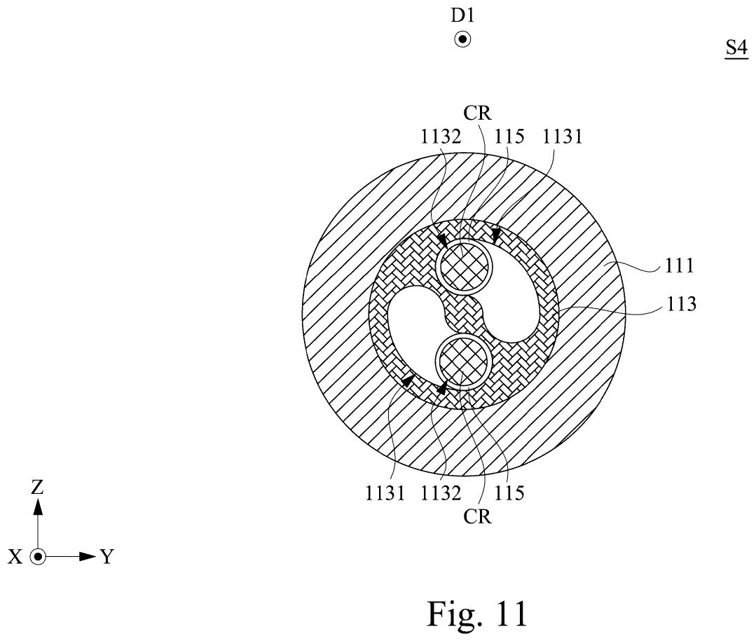

The safe connecting structure 100 of the present disclosure in the first state S1, the second state S2, the third state S3, and the fourth state S4 will be described in detail below. Please refer to FIG. 4 and FIG. 5 for better understanding of the safe connecting structure 100 in the first state S1, refer to FIG. 6 and FIG. 7 for better understanding of the safe connecting structure 100 in the second state S2, refer to FIG. 8 and FIG. 9 for better understanding of the safe connecting structure 100 in the third state S3, and refer to FIG. 10 and FIG. 11 for better understanding of the safe connecting structure 100 in the fourth state S4.

Reference is made to FIG. 4. FIG. 4 is a perspective cross-sectional view of the safe connecting structure 100 in the first state S1 based on a section A-A′ of FIG. 1 in accordance with an embodiment of the present disclosure. As shown in FIG. 4, in this embodiment, the first state S1 refers to a state in which the first connector 110 has not yet contacted the second connector 120. As shown in FIG. 4, the conductive rod CR passes through the first connecting bridge 114, and the conductive rod CR is extended from the first outer housing 111 along the joining direction toward the second connector 120. The conductive rod CR is fixed to the first connecting bridge 114. Specifically, when the safe connecting structure 100 is in the first state S1, the first end E1 of the conductive rod CR is located in the arc-shaped groove 1131 but is misaligned with the first opening 1132, and the conductive rod CR cannot contact the first conductive terminal 115 so that the conductive rod CR and the first conductive terminal 115 are in a non-conductive state. The second end E2 of the conductive rod CR does not pass through the through holes TH of the second connecting bridge 124 and the second opening 1232 of the second inner housing 123. As shown in FIG. 4, when the safe connecting structure 100 is in the first state S1, the conductive rod CR does not contact the first conductive terminal 115 and the second conductive terminal 125, so that the output cable OPC and the input cable IPC are not conductive. As shown in FIG. 4, the elastic part 116 has an elastic restoring force, so that the elastic part 116 abuts against between the first outer housing 111 and the first connecting bridge 114. In another embodiment, the elastic part 116 can also be disposed to abut against between the first inner housing 113 and the first connecting bridge 114.

As shown in FIG. 4, in some embodiments, a plurality of conductive rods CR are arranged along a direction (e.g., z-direction).

As shown in FIG. 4, the second opening 1232 of the second inner housing 123 and the through holes TH of the second connecting bridge 124 are aligned in the joining direction (e.g., x-direction) to accommodate the conductive rod CR.

As shown in FIG. 4, in some embodiments, the second conductive terminal 125 is tubular and has a cavity, and the cavity of the second conductive terminal 125 is configured to accommodate a portion of the conductive rod CR close to the second end E2. In other embodiments, the second conductive terminal 125 can also be designed in a rod shape or other suitable shape, and the second conductive terminal 125 can be connected to a contact surface of the conductive rod CR to be conductive.

Reference is made to FIG. 5. FIG. 5 is a cross-sectional view of the first connector 110 in the first state S1 based on a section B-B′ of FIG. 1 in accordance with an embodiment of the present disclosure. As shown in FIG. 5, in this embodiment, when the safe connecting structure 100 is in the first state S1, two conductive rods CR respectively abut against two arc-shaped grooves 1131. In some embodiments, the two conductive rods CR respectively abut one end of the two arc-shaped grooves 1131 and are not aligned with the first opening 1132 located at the other end of the two arc-shaped grooves 1131. It can be clearly seen from FIG. 5 that the conductive rod CR is not aligned with the first opening 1132 and cannot contact the first conductive terminal 115.

As shown in FIG. 5, in some embodiments, the first conductive terminal 115 is disposed on an inner wall of the first opening 1132. In some embodiments, the first conductive terminal 115 is tubular and has a cavity, and the cavity of the first conductive terminal 115 is configured to accommodate a portion of the conductive rod CR close to the first end E1 to be conductive. In other embodiments, the first conductive terminal 115 may also be designed in a rod shape or other suitable shape, and the first conductive terminal 115 can be connected to a contact surface of the conductive rod CR to be conductive.

As shown in FIG. 4 and FIG. 5, the conductive rods CR are arranged along a direction (e.g., z-direction), and a plurality of first conductive terminals 115 are arranged along a direction (e.g., y-direction). Therefore, in the first state S1, the conductive rod CR cannot be conductive to the power supply through the first conductive terminal 115 by staggering the positions of the conductive rod CR and the first conductive terminal 115. Therefore, there is no safety concern.

Reference is made to FIG. 6. FIG. 6 is a perspective cross-sectional view of the safe connecting structure 100 in a second state S2 based on the section A-A′ of FIG. 1 in accordance with an embodiment of the present disclosure. As shown in FIG. 6, in this embodiment, the second state S2 refers to a state in which the first connector 110 contacts the second connector 120 but the output cable OPC and the input cable IPC are not yet conductive. Specifically, when the safe connecting structure 100 alters to the second state S2 from the first state S1, the first connector 110 moves relatively toward the second connector 120 along the joining direction (i.e., a moving direction D1), and the second connector 120 moves relatively toward the first connector 110 along the joining direction (i.e., a moving direction D2). In other words, when the safe connecting structure 100 alters to the second state S2 from the first state S1, the first connector 110 and the second connector 120 move toward each other. In some embodiments, the first connector 110 is relatively stationary (e.g., fixed to a power supply device), and the second connector 120 moves toward the first connector 110 along the moving direction D2. In some embodiments, the second connector 120 is relatively stationary (e.g., fixed to a charging device), and the first connector 110 moves toward the second connector 120 along the moving direction D1.

Specifically, when the safe connecting structure 100 is in the second state S2, the first end E1 of the conductive rod CR still abuts against the arc-shaped groove 1131 but is not aligned with the first opening 1132 and not contact the first conductive terminal 115. The second end E2 of the conductive rod CR passes through the through holes TH of the second connecting bridge 124 and the second opening 1232 of the second inner housing 123. As shown in FIG. 6, when the safe connecting structure 100 is in the second state S2, the conductive rod CR does not contact the first conductive terminal 115 but contacts the second conductive terminal 125, so that the output cable OPC and the input cable IPC are still non-conductive. As shown in FIG. 6, when the safe connecting structure 100 is in the second state S2, the free end FE of the cantilever 122 enters the groove 112 through the entrance ET.

In a usage scenario, the user holds the first connector 110 and the second connector 120 with both hands respectively and moves the first connector 110 and the second connector 120 toward each other, so that the safe connecting structure 100 alters to the second state S2 from the first state S1 and the free end FE of the cantilever 122 enters the groove 112 through the entrance ET. In some embodiments, the first connector 110 moves toward the second connector 120 along the moving direction D1, and the second connector 120 moves toward the first connector 110 along the moving direction D2. In some embodiments, the first connector 110 is relatively stationary (e.g., fixed to the power supply device), and the user holds the second connector 120 such that the second connector 120 moves toward the first connector 110 along the moving direction D2. In some embodiments, the second connector 120 is relatively stationary (e.g., fixed to the charging device), and the user holds the first connector 110 such that the first connector 110 moves toward the second connector 120 along the moving direction D1.

As shown in FIG. 6, when the safe connecting structure 100 is in the second state S2, the second end E2 of the conductive rod CR is accommodated in the cavity of the second conductive terminal 125 without contacting the input cable IPC. However, the present disclosure is not limited thereto. For example, when the second end E2 of the conductive rod CR is accommodated in the cavity of the second conductive terminal 125, the second end E2 of the conductive rod CR can also contact the input cable IPC.

Reference is made to FIG. 7. FIG. 7 is a cross-sectional view of the first connector 110 in the second state S2 based on the section B-B′ of FIG. 1 in accordance with an embodiment of the present disclosure. The structural configuration of the first connector 110 shown in FIG. 7 is the same as the structural configuration of the first connector 110 shown in FIG. 5, and therefore will not be described again herein.

Reference is made to FIG. 8. FIG. 8 is a perspective cross-sectional view of the safe connecting structure 100 in a third state S3 based on the section A-A′ of FIG. 1 in accordance with an embodiment of the present disclosure. As shown in FIG. 8, in this embodiment, the third state S3 refers to a state in which the first connector 110 and the second connector 120 rotate relative to each other after the first connector 110 contacts the second connector 120 but the output cable OPC and the input cable IPC are not yet conductive. Specifically, when the safe connecting structure 100 alters to the third state S3 from the second state S2, the first connector 110 rotates relative to the second connector 120 along a rotating direction RT1, and the second connector 120 rotates relative to the first connector 110 along a rotating direction RT2. In other words, when the safe connecting structure 100 alters to the third state S3 from the second state S2, the first connector 110 and the second connector 120 rotate relative to each other around a rotation axis parallel to the joining direction (e.g., the x-direction in FIG. 8). In some embodiments, the first connector 110 is stationary (e.g., fixed to the power supply device), and the second connector 120 rotates relative to the first connector 110 along the rotating direction RT2 around the rotation axis parallel to the joining direction (e.g., x-direction in FIG. 8). In some embodiments, the second connector 120 is stationary (e.g., fixed to the charging device), and the first connector 110 rotates relative to the second connector 120 along the rotating direction RT1 around the rotation axis parallel to the joining direction (e.g., x-direction in FIG. 8).

As shown in FIG. 8, when the safe connecting structure 100 alters to the third state S3 from the second state S2, the free end FE of the cantilever 122 moves in the first groove 1121 along the rotating direction RT2, so that the free end FE of the cantilever 122 moves from an end of the first groove 1121 close to the entrance ET to an end of the first groove 1121 close to the second groove 1122. When the first connector 110 rotates relative to the second connector 120, the first outer housing 111 drives the first opening 1132 of the first inner housing 113 to rotate along the rotating direction RT1, so that the first opening 1132 is aligned with the first end E1 of the conductive rod CR in the joining direction (e.g., the x-direction in FIG. 8) but the conductive rod CR has not yet contacted the first conductive terminal 115. The second end E2 of the conductive rod CR still passes through the through holes TH of the second connecting bridge 124 and the second opening 1232 of the second inner housing 123. As shown in FIG. 8, when the safe connecting structure 100 is in the third state S3, the conductive rod CR does not contact the first conductive terminal 115 but contacts the second conductive terminal 125, so that the output cable OPC and the input cable IPC are still non-conductive.

In a usage scenario, the user holds the first connector 110 and the second connector 120 with both hands respectively and rotates the first connector 110 and the second connector 120 relative to each other, so that the safe connecting structure 100 alters to the third state S3 from the second state S2 and the free end FE of the cantilever 122 moves from the end of the first groove 1121 close to the entrance ET to the end of the first groove 1121 close to the second groove 1122. In some embodiments, the first connector 110 rotates relative to the second connector 120 along the rotating direction RT1, and the second connector 120 rotates relative to the first connector 110 along the rotating direction RT2. In some embodiments, the first connector 110 is relatively stationary, and the user holds the second connector 120 such that the second connector 120 rotates relative to the first connector 110 along the rotating direction RT2. In some embodiments, the second connector 120 is relatively stationary, and the user holds the first connector 110 such that the first connector 110 rotates relative to the second connector 120 along the rotating direction RT1.

In some embodiments, the first inner housing 113 is fixedly disposed in the first outer housing 111 and the first connecting bridge 114 is rotatably disposed in the first outer housing 111, so the first inner housing 113 can be driven by the first outer housing 111 to rotate relative to the first connecting bridge 114 around a rotation axis parallel to the joining direction (e.g., x-direction), so that the first opening 1132 of the first inner housing 113 is aligned to conductive rod CR.

As shown in FIG. 8, the output cable OPC contacts the first conductive terminal 115, and the input cable IPC contacts the second conductive terminal 125.

Reference is made to FIG. 9. FIG. 9 is a cross-sectional view of the first connector 110 in the third state S3 based on the section B-B′ of FIG. 1 in accordance with an embodiment of the present disclosure. The structural configuration shown in FIG. 9 is substantially similar to the structural configuration shown in FIG. 7, the difference between both is that the first connector 110 rotates relative to the second connector 120 along the rotating direction RT1. When the safe connecting structure 100 is in the third state S3, the two conductive rods CR are respectively aligned with the first opening 1132 located in the two arc-shaped grooves 1131. Therefore, the two conductive rods CR are also aligned with the first conductive terminal 115, respectively.

Reference is made to FIG. 10. FIG. 10 is a perspective cross-sectional view of the safe connecting structure 100 in a fourth state S4 based on the section A-A′ of FIG. 1 in accordance with an embodiment of the present disclosure. As shown in FIG. 10, in this embodiment, the fourth state S4 refers to a state in which the first connector 110 contacts the second connector 120 and the output cable OPC and the input cable IPC are conductive. Specifically, when the safe connecting structure 100 alters to the fourth state S4 from the third state S3, the first connector 110 continues to move relatively toward the second connector 120 along the moving direction D1, and the second connector 120 continues to move relatively toward the first connector 110 along the moving direction D2. In other words, when the safe connecting structure 100 alters to the fourth state S4 from the third state S3, the first connector 110 and the second connector 120 move toward each other. In some embodiments, the first connector 110 is relatively stationary, and the second connector 120 moves toward the first connector 110 along the moving direction D2. In some embodiments, the second connector 120 is relatively stationary, and the first connector 110 moves toward the second connector 120 along the moving direction D1.

Specifically, when the safe connecting structure 100 is in the fourth state S4, the first connector 110 and the second connector 120 are further pushed together along the joining direction, and the first end E1 of the conductive rod CR penetrates the first opening 1132 to contact the first conductive terminal 115. The second end E2 of the conductive rod CR still passes through the through holes TH of the second connecting bridge 124 and the second opening 1232 of the second inner housing 123 and contacts the second conductive terminal 125. As shown in FIG. 10, when the safe connecting structure 100 is in the fourth state S4, the conductive rod CR contacts the first conductive terminal 115 and the second conductive terminal 125 at the same time, and the first conductive terminal 115 and the second conductive terminal 125 are in a conductive state by the conductive rod CR, so that the output cable OPC and the input cable IPC are conductive. As shown in FIG. 10, when the safe connecting structure 100 alters to the fourth state S4 from the third state S3, the first connector 110 and the second connector 120 move toward each other along the joining direction (e.g., x-direction), so that the free end FE of the cantilever 122 moves in the second groove 1122 along the joining direction. When the free end FE of the cantilever 122 abuts the end of the second groove 1122, the free end FE is buckled into the recess 1123. At this time, the first connecting bridge 114 moves toward the first outer housing 111 (or the first inner housing 113) to compress the elastic part 116. Since the free end FE buckled in the recess 1123, the free end FE and the recess 1123 can maintain its position without being disengaged in the fourth state S4 after the first connector 110 and the second connector 120 is connected. In the fourth state S4, if the first connector 110 and the second connector 120 are pulled apart so that the free end FE is disengaged from the recess 1123, the elastic part 116 will restore to allow the first connecting bridge 114 to move away from the first outer housing 111 (or the first inner housing 113), causing the conductive rod CR not to contact the first conductive terminal 115, thereby ensuring that the conductive rod CR is in the non-conductive state immediately.

In a usage scenario, the user holds the first connector 110 and the second connector 120 with both hands respectively and moves the first connector 110 and the second connector 120 toward each other, so that the safe connecting structure 100 alters to the fourth state S4 from the third state S3 and the free end FE of the cantilever 122 moves along the second groove 1122 and be buckled into the recess 1123. In some embodiments, the first connector 110 moves toward the second connector 120 along the moving direction D1, and the second connector 120 moves toward the first connector 110 along the moving direction D2. In some embodiments, the first connector 110 is relatively stationary, and the user holds the second connector 120 so that the second connector 120 moves toward the first connector 110 along the moving direction D2. In some embodiments, the second connector 120 is relatively stationary, and the user holds the first connector 110 so that the first connector 110 moves toward the second connector 120 along the moving direction D1. Accordingly, the second connector 120 is coupled with the first connector 110 so that the output cable OPC and the input cable IPC are conductive and the conductive rod CR is not exposed.

As shown in FIG. 10, when the safe connecting structure 100 is in the fourth state S4, the first end E1 of the conductive rod CR is accommodated in the cavity of the first conductive terminal 115 without contacting the output cable OPC, and the second end E2 of the conductive rod CR is accommodated in the cavity of the second conductive terminal 125 without contacting the input cable IPC, but the present disclosure is not limited thereto. For example, the first end E1 of the conductive rod CR may also contact the output cable OPC, and the second end E2 of the conductive rod CR may also contact the input cable IPC.

Reference is made to FIG. 11. FIG. 11 is a cross-sectional view of the first connector 110 in the fourth state S4 based on the section B-B′ of FIG. 1 in accordance with an embodiment of the present disclosure. Since the structural configuration shown in FIG. 11 is the same as that shown in FIG. 9, and therefore will not be described again herein.

In some embodiments, a process of removing the second connector 120 from the first connector 110 is as follows. The safe connecting structure 100 can detach the second connector 120 from the first connector 110 by changing from the fourth state S4 to the third state S3, to the second state S2, and then to the first state S1. When the safe connecting structure 100 alters to the third state S3 from the fourth state S4, the first connector 110 and the second connector 120 are pulled apart along the joining direction (e.g., x-direction) and move away to each other. Since the elastic part 116 has elastic restoring force, the first connecting bridge 114 is pushed away from the first inner housing 113, and the first end E1 of the conductive rod CR fixed to the first connecting bridge 114 therefore leaves the first opening 1132 without contacting the first conductive terminal 115, thereby allowing the first conductive terminal 115 and the conductive rod CR are in the non-conductive state. When the safe connecting structure 100 alters to the second state S2 from the third state S3, the first connector 110 and the second connector 120 rotate relative to each other, and the first outer housing 111 drives the first inner housing 113 to rotate accordingly, so that the first opening 1132 is not aligned with the conductive rod CR and the first conductive terminal 115 and the conductive rod CR are still in the non-conductive state. When the safe connecting structure 100 alters to the first state S1 from the second state S2, the first connector 110 and the second connector 120 are further pulled apart along the joining direction (e.g., x-direction) and move away to each other, so that the conductive rod CR leaves the second connector 120 and the first conductive terminal 115 and the conductive rod CR are still in the non-conductive state. Accordingly, the user can safely detach the second connector 120 from the first connector 110.

By using the safe connecting structure 100 shown in the present disclosure, it can be ensured that the conductive rod CR and the first conductive terminal 115 are in a non-conductive state as the conductive rod CR is exposed. Therefore, when the conductive rod CR is exposed, the conductive rod CR and the output cable OPC are both in the non-conductive state and can comply with various safety regulations, so that the user can safely operate the safe connecting structure 100 to avoid the risk of electric shock.

From the above detailed description of the specific embodiments of the present disclosure, it can be clearly seen that in the safe connecting structure and the safe connector of the present disclosure, since the first inner housing has the first opening, the conductive rod can be blocked first and not immediately pass through the first opening and contact the first conductive terminal as the user couples the first connector and the second connector, thereby achieving the effect of non-conducting while the conductive rod is still exposed. In the safe connecting structure and safe connector of the present disclosure, since the arc-shaped groove has an arc shaped and is configured for the conductive rod to abut against, the arc-shaped groove can guide the conductive rod to move in the arc-shaped groove as the first connector and the second connector rotate relative to each other. Overall, the safe connecting structure and safe connector of the present disclosure improve the safety of the user using the connector.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A safe connecting structure, comprising:
a first connector, comprising:
a first outer housing;
a first inner housing located in the first outer housing, the first inner housing having a first opening;
a first conductive terminal located in the first opening of the first inner housing;
a first connecting bridge accommodated in the first outer housing and rotatable in the first outer housing; and
a conductive rod passing through the first connecting bridge and fixed to the first connecting bridge, the conductive rod protruding outward from the first outer housing along a joining direction; and
a second connector removably connected to the first connector, comprising:
a second outer housing configured to be coupled to the first outer housing; and
a second conductive terminal located in the second outer housing;
wherein the conductive rod is not aligned with the first opening and is in a non-conductive state with the first conductive terminal in the first opening, as the first connector is not connected to the second connector; and
wherein the conductive rod is connected to the second conductive terminal, and the first outer housing rotates relative to the second outer housing around a rotation axis parallel to the joining direction, wherein the first inner housing rotates with the first outer housing until the first opening is aligned with the conductive rod, wherein the first connector and the second connector are further pushed together along the joining direction, such that the conductive rod passes through the first opening to connect the first conductive terminal, and the first conductive terminal is in a conductive state with the second conductive terminal by the conductive rod, as the first connector is connected to the second connector along the joining direction.

2. The safe connecting structure of claim 1, wherein the first connector comprises a first guiding mechanism and the second connector comprises a second guiding mechanism, and the first guiding mechanism and the second guiding mechanism are configured to assist the first connector and the second connector to move or rotate relative to each other.

3. The safe connecting structure of claim 2, wherein the first guiding mechanism comprises a groove disposed on an outer surface of the first outer housing, and the groove has a first groove, a second groove communicating with the first groove, and a recess located at an end of the second groove, wherein the second guiding mechanism comprises a cantilever disposed on an outer surface of the second outer housing, and the cantilever has a free end and a fixed end fixed to the second outer housing, wherein the free end of the cantilever moves in the first groove and the second groove as the first connector and the second connector move or rotate relative to each other.

4. The safe connecting structure of claim 3, wherein the free end of the cantilever moves in the first groove as the first outer housing rotates relative to the second outer housing, wherein the free end of the cantilever moves in the second groove after the first opening is aligned with the conductive rod and the first connector and the second connector are further pushed together along the joining direction.

5. The safe connecting structure of claim 4, wherein as the first connector and the second connector are further pushed together along the joining direction, the free end of the cantilever moves in the second groove, so that the free end of the cantilever is buckled in the recess.

6. The safe connecting structure of claim 2, wherein the second guiding mechanism comprises a groove disposed on an outer surface of the second outer housing, and the groove has a first groove, a second groove communicating with the first groove, and a recess located at an end of the second groove, wherein the first guiding mechanism comprises a cantilever disposed on an outer surface of the first outer housing, and the cantilever has a free end and a fixed end fixed to the second outer housing, wherein the free end of the cantilever moves in the first groove and the second groove as the first connector and the second connector move or rotate relative to each other.

7. The safe connecting structure of claim 6, wherein the free end of the cantilever moves in the first groove as the first outer housing rotates relative to the second outer housing, wherein the free end of the cantilever moves in the second groove after the first opening is aligned with the conductive rod and the first connector and the second connector are further pushed together along the joining direction.

8. The safe connecting structure of claim 7, wherein as the first connector and the second connector are further pushed together along the joining direction, the free end of the cantilever moves in the second groove, so that the free end of the cantilever is buckled in the recess.

9. The safe connecting structure of claim 1, wherein the first inner housing further comprises an arc-shaped groove disposed adjacent to a surface of the first connecting bridge, and the first opening of the first inner housing is connected to an end of the arc-shaped groove.

10. The safe connecting structure of claim 1, wherein the second connector further comprises a second inner housing located in the second outer housing, and the second inner housing has a second opening to accommodate the second conductive terminal.

11. The safe connecting structure of claim 1, wherein the second connector further comprises a second connecting bridge, and the conductive rod passes through the second connecting bridge and is connected to the second conductive terminal.

12. The safe connecting structure of claim 1, wherein the first connector further comprises an elastic part disposed between the first inner housing and the first connecting bridge.

13. A safe connector, comprising:
an outer housing;
an inner housing located in the outer housing, the inner housing having an opening;
a conductive terminal located in the opening of the inner housing;
a connecting bridge accommodated in the outer housing and rotatable in the outer housing; and
a conductive rod passing through the connecting bridge and fixed to the connecting bridge, the conductive rod protruding outward from the outer housing along a joining direction;
wherein the conductive rod is not aligned with the opening and is in a non-conductive state with the conductive terminal in the opening as the safe connector is in an unconnected state; and
wherein the conductive rod passes through the opening to connect the conductive terminal, such that the conductive terminal is in a conductive state with the conductive rod, as the inner housing rotates relative to the connecting bridge around a rotation axis parallel to the joining direction until the opening is aligned with the conductive rod, and the inner housing and the connecting bridge are further pushed together along the joining direction.

14. The safe connector of claim 13, wherein an outer surface of the outer housing has a first groove, a second groove connected to the first groove, and a recess located at an end of the second groove.

15. The safe connector of claim 13, wherein an outer surface of the outer housing has a cantilever, and the cantilever has a free end and a fixed end fixed to the outer housing.

16. The safe connector of claim 13, wherein the inner housing further comprises an arc-shaped groove disposed adjacent to a surface of the connecting bridge, and the opening of the inner housing is connected to an end of the arc-shaped groove, wherein an end of the conductive rod close to the inner housing moves along the arc-shaped groove as the inner housing rotates relative to the connecting bridge.

17. The safe connector of claim 13, further comprising an elastic part disposed between the inner housing and the connecting bridge.
